(19) United States
(12) Patent Application Publication
(10) Pub. No.: US 2023/0042819 A1
(43) Pub. Date: Feb. 9, 2023

(54) SCINTILLATION DETECTOR

(71) Applicant: KROMEK LIMITED, Sedgefield Durham (GB)

(72) Inventors: Edward Marsden, Huddersfield (GB); John Atkins, Sedgefield (GB)

(21) Appl. No.: 17/784,235

(22) PCT Filed: Dec. 11, 2020
(86) PCT No.: PCT/GB2020/053181

§ 371 Date: Jun. 10, 2022

(30) Foreign Application Priority Data
Dec. 12, 2019 (GB) 1918339.1

(51) Int. Cl. G01T 1/20

(52) U.S. Cl. CPC G01T 1/2002; G01T 1/2018

(57) ABSTRACT

A scintillator unit is described for use in a radiation detector assembly comprising: a scintillator comprising a scintillating material; a wrapping layer at least partly covering an external surface of the scintillating material; wherein the wrapping layer comprises a composite layer including a first layer of diffusively reflective material and a second layer of specularly reflective material. A radiation detector assembly including a scintillator unit is also described. Methods of fabrication of the same are also described.

The invention relates to a scintillation detector such as might be used for example for the detection of ionising radiation including high-energy electromagnetic radiation and in particular gamma rays, or for the detection of subatomic particle radiation including neutrons, and to a scintillator unit for use in the same. The invention in particular relates to modifications to a scintillation detector with a view to adapting the same for use in a portable radiation detector device. The invention further relates to a portable radiation detector device including such a scintillation detector. The invention further relates to methods of fabrication of the same.

### BACKGROUND TO THE INVENTION

It is a long-established principle that an efficient radiation detector can be constructed for the detection of high-energy ionising radiation using in combination a scintillator material which exhibits scintillation when excited by the ionising radiation and emits photons as a result, and a photodetector to detect those photons. The photodetector enables an electrical signal to be obtained indicative of the response of the scintillator, and consequently from which incoming radiation incident at the scintillator can be detector and characterised.

The use of a scintillation detector comprising a scintillator and a suitable photodetector is widespread in the field of radiation detection and monitoring, and may find particular application in the development of compact portable and for example hand-held radiation monitoring meters, such as might be used for detecting and quantifying/characterising radioactive contamination, for the monitoring of radioactive materials and sources, for the monitoring of potentially contaminated environments and for similar applications. There is a general desire therefore to develop scintillation detectors in which the scintillator and detector and other suitable detection control systems and electronics can be associated together in a compact and efficient manner, for example in such a portable system.

Various scintillator materials are well known. Known scintillator materials include organic scintillators and inorganic scintillators. Certain inorganic scintillators may be particularly suited to use in compact detectors, and for example portable detectors. Known classes of inorganic scintillator include doped alkali halides, such as NaI(TI), CsI(TI), CsI(Na), LiI(Eu); other slow inorganics such as BGO, CdWO₄, ZnS(Ag); Ce³⁺-activated fast inorganics such as lanthanum chloride (LaCl₃(Ce)), lanthanum bromide (LaBr₃(Ce)), CLLB (Cs₂LiLaBr₆(Ce)), GSO (Gd₂SiO₅(Ce)), YAP, YAG, LSO, LuAP, and the like. Many of this last class in particular are highly hygroscopic.

Suitable photodetectors, particularly for compact and for example portable operation, include photomultipliers. Suitable photomultipliers include photomultiplier tubes (PMT) and photodiodes. Solid state photomultipliers, including silicon photomultipliers (SiPMs) are particularly suited to application in compact and for example portable detectors.

In scintillation detectors, a photodetector is typically optically coupled to one face of a scintillator such as an inorganic crystal scintillator. To achieve optimum performance, the following two basic performance features are required:
1. The maximum number of photons generated in each scintillation event in the scintillator should reach the photodetector;
2. For a fixed excitation energy, the same number of photons should be collected at the photodetector consistently, regardless of where in the scintillator the excitation event occurred.

In the case of inorganic crystal scintillators in particular, these two objectives are usually achieved by wrapping the scintillator crystal in a high reflective optically diffusing material. Expanded polytetrafluoroethylene (PTFE) is commonly used. However, this material requires a thickness of 2-3 mm to achieve the reflectivity needed for optimum performance, which can lead to the resultant assembled detector being more bulky than might be desired for compact and for example hand-held devices.

Alternative high reflectivity thin films are available. However, these tend to be specular reflectors and consequently less effective when used for this purpose.

It is generally desirable to provide a scintillator unit for a scintillation detector assembly and a scintillation detector assembly incorporating such a scintillator unit which mitigate one or more of the above disadvantages.

It is in particularly desirable to provide a scintillator unit for a scintillation detector assembly and a scintillation detector assembly incorporating such a scintillator unit which include a means and method of wrapping the scintillator material with a reflective material that enhances the efficiency and consistency of collection of photons generated from a given scintillation event.

It is particularly desirable to provide a scintillator unit for a scintillation detector assembly and a scintillation detector assembly incorporating such a scintillator unit which include a means and method of wrapping the scintillator material with a reflective material that lends itself to the production of compact and for example portable and hand-held detectors.

### SUMMARY OF INVENTION

In accordance with the invention in a first aspect, a scintillator unit for use in a radiation detector assembly comprises:

a scintillator comprising a scintillating material;

a wrapping layer at least partly covering an external surface of the scintillating material;

wherein the wrapping layer comprises a composite layer including a first layer of diffusively reflective material and a second layer of specularly reflective material.

The scintillating material comprises a material adapted to exhibit a scintillation response to incident high-energy electromagnetic radiation and in particular gamma rays, or to subatomic particle radiation including neutrons, and thereby to emit photons, for example in or nearer to the visible range.

In typical use, as will be familiar, the scintillator is used with a photodetector in a scintillation detector. The photodetector is optically coupled to the scintillator in the sense that it is positioned relative to the scintillator to receive at least a proportion of the said emitted photons and to generate an electrical signal in response. For example, an emission surface of the scintillator is positioned in proximity to a receiving surface of the photodetector. This electrical signal may be used to draw inferences regarding the radiation incident at the scintillator, whereby incoming radiation incident at the scintillator can be detected and characterised.

The invention is characterized by the use of a wrapping for the scintillator that comprises a composite layer including a layer of diffusively reflective material combined with a layer of specularly reflective material. The composite wrapping thereby combines diffusively reflective and specularly reflective properties in an effective manner. In the case of inorganic crystal scintillators in particular, the invention is effective in optimizing performance by providing a high reflectivity optically diffusing wrapping material covering at least a major part of the surface of the scintillator that is not optically coupled to the photodetector. The composite approach of the invention combines the high diffusing behaviour exhibited in the prior art use of expanded PTFE with high reflectivity in a wrapping that has all the performance of the PTFE approach but requires much less thickness, for example 200-300 μm rather than 2-3 mm.

As used herein it will be understood that a diffusively reflective material comprises a material that exhibits a predominantly and for example substantially diffuse mode of reflection to radiation of the energy range emitted by the scintillator, and that a specularly reflective material comprises a material that exhibits a predominantly and for example substantially specular mode of reflection to radiation of the energy range emitted by the scintillator.

The layer of diffusively reflective material preferably comprises a diffusively reflective flexible film. The layer of specularly reflective material preferably comprises a specularly reflective flexible film. The composite wrapping layer may thus conveniently comprise a flexible composite wrapping film.

The layer of diffusively reflective material preferably comprises a layer of polymeric material and for example a layer of flexible polymeric material sheet. The layer of specularly reflective material preferably comprises a layer of metallic material and for example comprises a layer of reflective metal foil or a layer of metallised polymer sheet. The composite layer thus preferably comprises a layer of flexible polymeric material and a layer of reflective foil and examples are discussed herein in non-limiting manner based on this preferred embodiment.

The diffusively reflective material such as the flexible polymeric material is selected to be optically diffusing of photons at the energy emitted by the scintillator. Suitable selection for such materials will be within the general competence of the person skilled in the art.

Optically diffusing polymeric materials are known, and the layer of flexible polymeric material comprises a film incorporating one or more such materials. In an embodiment, the optically diffusing material is polytetrafluoroethylene (PTFE) and the layer of flexible polymeric material comprises PTFE film.

The specularly reflective material such as the layer of reflective foil comprises a material selected to be highly reflective of photons at the energy emitted by the scintillator. Suitable selection for such materials will be within the general competence of the person skilled in the art.

Known reflective materials include metal sheets and highly reflective metallised polymer sheets, and the layer of specularly reflective material comprises one or more such materials.

Preferably, the layer of diffusively reflective material has a thickness of less than 2 mm and for example of between 0.1 mm and 1 mm.

Preferably, the layer of specularly reflective material has a thickness of less than 200 microns and for example of between 10 μm and 100 μm.

Preferably the composite wrapping layer has a thickness of less than 2.1 mm and for example of between 110 μm and 1100 μm.

The composite wrapping layer may optionally include additional layers.

In a preferred embodiment the layer of diffusively reflective material is located closer to the scintillator than the layer of specularly reflective material.

Optionally, the composite wrapping layer may comprise the layer of diffusively reflective material directly overlaid by the layer of specularly reflective material. For example, the composite wrapping layer may be a film may comprising a layer of flexible polymeric material directly overcoated with a layer of reflective foil.

In some embodiments the layer of specularly reflective material comprises the outermost layer of the composite wrapping layer.

In some embodiments a space may be provided between the layer of diffusively reflective material and an external surface of the scintillator to encourage internal reflection of photons emitted by the scintillator in use at the surface. The space may be an air gap. Additionally or alternatively a spacing layer of low refractive index material may be disposed between the layer of diffusively reflective material and an external surface of the scintillator.

The scintillating material preferably comprises a crystalline scintillating material. The scintillating material is for example an inorganic crystalline scintillating material. The scintillating material is for example a single crystal.

Suitable inorganic scintillating materials for use in the invention include doped alkali halides, such as NaI(TI), CsI(TI), CsI(Na), LiI(Eu); other slow inorganics such as BGO, CdWO₄, ZnS(Ag); Ce³⁺-activated fast inorganics such as lanthanum chloride (LaCl₃(Ce)), lanthanum bromide (LaBr₃(Ce)), CLLB (Cs₂LiLaBr₆(Ce)), GSO (Gd₂SiO₅(Ce)), YAP, YAG, LSO, LuAP, and the like.

In a more complete aspect of the invention, a radiation detector assembly is provided comprising:

a scintillator unit in accordance with the first aspect;

a photodetector.

Suitable photodetectors, particularly for compact and for example portable operation, include photomultipliers. Suitable photomultipliers include photomultiplier tubes (PMT) and photodiodes. Solid state photomultipliers, including silicon photomultipliers (SiPMs) are particularly suited to application in compact and for example portable detectors.

The radiation detector assembly may be provided in a suitable housing. The housing may be adapted to provide an enclosed volume in which the components therein are mechanically and/or environmentally protected, and for example hermetically sealed.

The radiation detector assembly may further comprise and where applicable the housing may further contain other appropriate components to facilitate the function of the detector assembly within a detector device, for example including without limitation a power source, such as a battery; a data processing module configured for one or more of: collecting electronic signals from the photodetector indicative of radiation incident at the scintillator, processing the collected data, analysing the collected data to draw inferences regarding the incident radiation; a data transmission module configured to transmit the collected data and/or the results of an analysis of the collected data to an external receiver and for example an external processor. The control and processing electronics may for example be performed by, the data processing module may correspondingly comprise, and the enclosure may correspondingly contain, a suitable ASIC.

The housing may optionally further contain means configured to receive data from an external control system; means to receive power from an external power source.

The radiation detector assembly may additionally include and/or be adapted to adapted to communicate remotely with suitable control and processing electronics.

The radiation detector assembly may additionally include and/or be adapted to connect remotely with a suitable power source. The power source may be a battery and for example a rechargeable battery.

The radiation detector assembly may include a suitable display adapted to display information regarding detected radiation.

The radiation detector assembly may include a wired or wireless transmitter or transceiver adapted to communicate information regarding detected radiation to/with a remote data station.

The radiation detector assembly may include a suitable housing.

In a preferred embodiment, the radiation detector assembly is adapted to be portable, and for example adapted to be hand-held in use. For example, it comprises a housing adapted to associate components of the radiation detector together compactly in a portable manner, and for example adapted to be hand-held in use.

In accordance with the invention in a further aspect, a method of fabrication of a scintillator unit comprises:

providing a scintillator comprising a scintillating material;

at least partly covering an external surface of the scintillating material with a wrapping layer;

wherein the wrapping layer comprises a composite layer including a first layer of diffusively reflective material and a second layer of specularly reflective material.

The invention is this further aspect is thus a method of fabrication of a scintillator unit in accordance with the first aspect of the invention, and further features will be understood by analogy with the foregoing description of the first aspect of the invention.

In particular, preferred materials for the layer of diffusively reflective material and the layer of specularly reflective material, and preferred structural features and dimensions, will be understood from the foregoing.

Preferred scintillating materials will similarly be understood from the foregoing, and will in particular comprise crystallised scintillating materials, and for example inorganic crystalline scintillating materials, and for example single crystals as above described.

Similarly, in a more complete aspect of the method, a method of fabrication of a radiation detector assembly is provided comprising the additional step of providing a photodetector, and optically coupling the same with the scintillator. The photodetector is optically coupled to the scintillator in the sense that it is positioned relative to the scintillator to receive at least a proportion of the photons emitted therefrom and to generate an electrical signal in response. For example, an emission surface of the scintillator is positioned in proximity to a receiving surface of the photodetector.

The method of this aspect of the invention is thus a method of fabrication of a radiation detector assembly in accordance with the second aspect of the invention, and further preferred features of the method will be understood by analogy with the discussion of that aspect.

In particular for example, the method may comprise associating the scintillator unit, the photodetector, and optional further components, together in a suitable housing. The housing may be adapted to provide an enclosed volume in which the components are mechanically and environmentally protected, and may for example be hermetically sealed.

The radiation detector assembly may be incorporated into a radiation detector, and in particular into a radiation detector that is adapted to be portable, and for example adapted to be hand-held in use.

Further preferred features of the method aspects of the invention will be understood by analogy with the discussion of the apparatus aspects and vice versa.

### BRIEF DESCRIPTION OF DRAWINGS

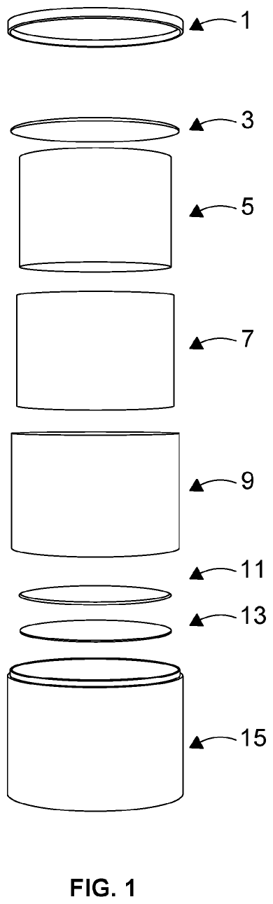

The invention will now be described by way of example only with reference to FIG. 1 of the accompanying drawings, which shows a scintillator assembly including a scintillator unit in accordance with an embodiment of the first aspect of the invention in exploded view.

### DETAILED DESCRIPTION

FIG. 1 shows a scintillator assembly illustrative of various aspects of the invention in exploded view.

The assembly includes, from the top, a housing lid (1), a photodetector PCB and flex (3), an inorganic crystalline scintillator which in the embodiment is CLLB (5), a PTFE wrapping layer (7) and reflective foil wrapping layer sitting outside the PTFE layer in use (9), a PTFE base layer (11), a neoprene support layer (13), and a housing body (15).

When suitably assembled, the outer cylindrical surface of the scintillator is consequently covered first by the PTFE layer and then by the reflective foil layer. The combined effect of this composite covering is to produce in combination: the high diffusing behaviour of conventional expanded PTFE wrapping without the disadvantage of the conventionally required thickness; and the high reflectivity of the foil layer while mitigating the disadvantages usually associated with the specular nature of the reflectivity of such foils. In consequence, a layer thickness of around 200-300 μm is achievable, and the whole assembly is particularly adapted to compact construction which can readily be incorporated into portable and for example hand-held detectors.

Other combinations of a layer of flexible polymeric material and layer of reflective foil, and optional further layers, will readily suggest themselves. The layers are preferably juxtaposed such that the flexible polymeric material is disposed closer to an external surface of the inorganic crystalline scintillating material and the layer reflective foil is disposed more distantly from the inorganic crystalline scintillating material and for example constitutes an outer surface of the wrapping.

The composite film of the embodiment of the invention thus uses a thin layer specularly reflective foil and a thin layer of diffusing material to provide both high diffusing behaviour and high reflectivity in a wrapping that requires much less thickness.

For example, the composite wrapping film of the invention has a thickness of less than 2.1 mm and for example of between 110 microns and 1100 microns.

The active components of the assembly are shown in a suitable housing which provides an enclosure volume in which the components are mechanically and environmentally protected. The enclosure volume comprises a housing body and a housing lid. The housing body defines an enclosure volume into which the components are received, and on to which the lid is then sealed. The housing may provide a hermetically enclosure to protect delicate and for example hygroscopic scintillator crystals from the external environment.

The illustrated housing may then be incorporated into a suitable portable and for example hand-held detector with other associated processing and control electronics, power source and the like.

1. A scintillator unit for use in a radiation detector assembly comprising:
a scintillator comprising a scintillating material;
a wrapping layer at least partly covering an external surface of the scintillating material;
wherein the wrapping layer comprises a composite layer including a first layer of diffusively reflective material and a second layer of specularly reflective material.

2. A scintillator unit in accordance with claim 1 wherein the layer of diffusively reflective material comprises a diffusively reflective flexible film.

3. A scintillator unit in accordance with claim 2 wherein the layer of diffusively reflective material comprises a layer of flexible polymeric material sheet.

4. A scintillator unit in accordance with claim 3 wherein the layer of diffusively reflective material comprises a layer of PTFE sheet.

5. A scintillator unit in accordance with claim 1 wherein the layer of specularly reflective material comprises a specularly reflective flexible film.

6. A scintillator unit in accordance with claim 5 wherein the layer of specularly reflective material comprises a layer of metallic material and for example comprises a layer of reflective metal foil or a layer of metallised polymer sheet.

7. A scintillator unit in accordance with claim 1 wherein the layer of diffusively reflective material has a thickness of less than 2 mm and for example of between 0.1 mm and 1 mm.

8. A scintillator unit in accordance with claim 1 wherein the layer of specularly reflective material has a thickness of less than 200 microns and for example of between 10 μm and 100 μm.

9. A scintillator unit in accordance with claim 1 wherein the layer of diffusively reflective material is located closer to the scintillator than the layer of specularly reflective material.

10. A scintillator unit in accordance with claim 1 wherein the wrapping layer comprises the layer of diffusively reflective material directly overlaid by the layer of specularly reflective material.

11. A scintillator unit in accordance with claim 1 wherein the layer of specularly reflective material comprises the outermost layer of the wrapping layer.

12. A scintillator unit in accordance with claim 1 wherein the scintillating material is an inorganic crystalline scintillating material.

13. A scintillator unit in accordance with claim 12 wherein the inorganic scintillating material is selected from one or more of: doped alkali halides, such as NaI(TI), CsI(TI), CsI(Na), LiI(Eu); other slow inorganics such as BGO, CdWO₄, ZnS(Ag); Ce³⁺-activated fast inorganics such as lanthanum chloride (LaCl₃(Ce)), lanthanum bromide (LaBr₃(Ce)), CLLB (Cs₂LiLaBr₆(Ce)), GSO (Gd₂SiO₅(Ce)), YAP, YAG, LSO, LuAP, and the like.

14. A radiation detector assembly comprising:
a scintillator unit comprising:
a scintillating material;
a wrapping layer at least partly covering an external surface of the scintillating material, wherein the wrapping layer comprises a composite layer including a first layer of diffusively reflective material and a second layer of specularly reflective material;
a photodetector optically coupled to the scintillator.

15. A radiation detector assembly in accordance with claim 14 wherein the assembly is adapted to be portable in that it comprises a housing adapted to associate components of the radiation detector together compactly in a portable manner, and for example adapted to be hand-held in use.

16. A method of fabrication of a scintillator unit comprising:
providing a scintillator comprising a scintillating material;
at least partly covering an external surface of the scintillating material with a wrapping layer;
wherein the wrapping layer comprises a composite layer including a first layer of diffusively reflective material and a second layer of specularly reflective material.

17. The method of claim 16 further comprising optically coupling a photodetector with the scintillator.
